(19) United States
(12) Patent Application Publication
(10) Pub. No.: US 2009/0082880 A1
(43) Pub. Date: Mar. 26, 2009

(54) WIRELESS DEVICE FOR A BUILDING CONTROL SYSTEM

(75) Inventor: Andrew T. Saunders, Richmond, VA (US)

Correspondence Address: HONEYWELL INTERNATIONAL INC., 101 COLUMBIA ROAD, P O BOX 2245, MORRISTOWN, NJ, 07962-2245, US

(73) Assignee: Tridium Inc.

(21) Appl. No.: 11/858,697

(22) Filed: Sep. 20, 2007

(51) Int. Cl. G05B 15/02

(52) U.S. Cl. 700/9

(57) ABSTRACT

A wireless adapter module receives data from a monitor device through a wired interface, where the data conforms to a first protocol. The wireless adapter device translates the data to a format compatible with a supervisory control system. The data is transmitted to the supervisory control system through a wireless interface. Various protocols and translations may be used within the wireless adapter module such that a single supervisory control system may communicate with a variety of different vendor's monitor devices.

### FIELD

Embodiments of the inventive subject matter relate generally to control systems and more particularly to a wireless device for a control system.

### BACKGROUND

It is common for restaurants, convenience stores and similar businesses to have a variety of equipment that may include control modules or sensors such as temperature sensors, level sensors etc. For example, sensors may be present on ovens, refrigerators, coffee machines, drink dispensers, grease traps etc. Typically, many different vendors may provide these devices, and each vendor's equipment may communicate sensor or control data according to proprietary protocols that are different from vendor to vendor. Thus a single business may have multiple pieces of equipment having sensors capable of providing data, however the data may be provided in different formats on each piece of equipment, where no one system may communicate with all of the multiple pieces of equipment.

### BRIEF DESCRIPTION OF THE FIGURES

Embodiments of the invention are illustrated by way of example and not limitation in the Figures of the accompanying drawings in which:

FIG. 1 is a block diagram illustrating an operating environment in which example embodiments of the invention may be practiced.

FIG. 2 is a block diagram illustrating components of a wireless adapter module according to embodiments of the invention.

FIG. 3 is a flowchart illustrating methods for operating a wireless adapter module according to embodiments of the invention.

### DESCRIPTION OF THE EMBODIMENTS

### Example Operating Environment

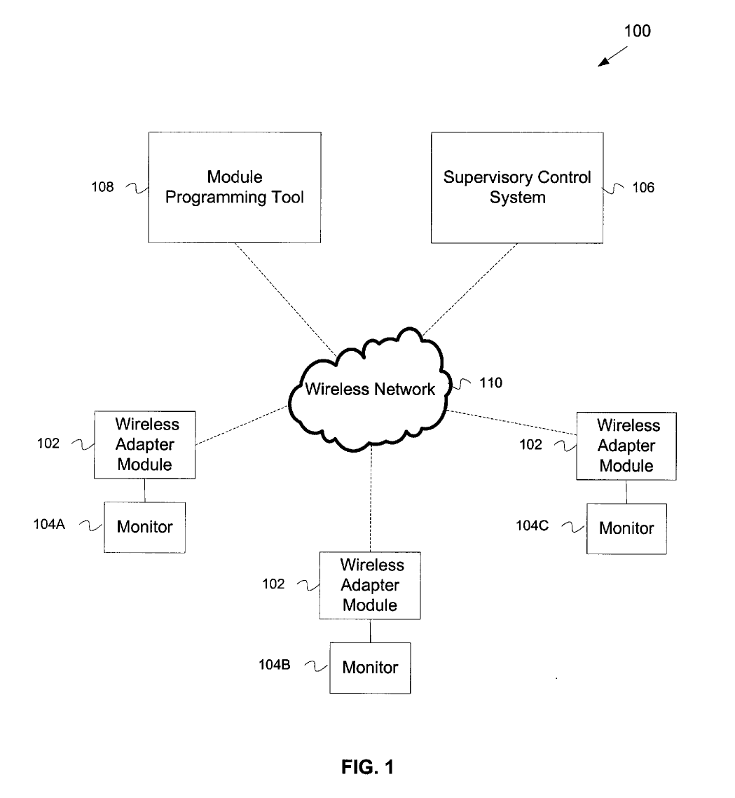

FIG. 1 is a block diagram illustrating an operating environment 100 in which example embodiments of the invention may be practiced. In general, environment 100 may operate in a small building or retail location such as a restaurant, convenience store, or other building having less than approximately 200,000 square feet. Environment 100 may include one or more wireless adapter modules 102, monitors 104A-C, supervisory control system 106 and module programming tool 108. These components may be communicably coupled using one or more networks, including a wireless network 110.

In some embodiments, supervisory control system 106 provides one or more applications and/or stores data for an automation system. The supervisory control system 106 may include multiple modules or applications that provide monitoring, control and asset management for various modules and equipment in an automation system. For example, supervisory control system 106 may include an application server may provide for the provisioning of devices on a system and may provide a database to store data related to devices for an automation system. Further, supervisory control system 106 may provide an archive or repository for log and alarm data generated or determined from devices coupled to system 100 and interfaces to display such data. In particular embodiments, supervisory control system 106 is the Niagara Framework® available from Tridium, Inc. of Richmond, Virginia. Further details on a supervisory control system used in various embodiments is provided in U.S. Pat. No. 6,832,120 entitled “SYSTEM AND METHODS FOR OBJECT-ORIENTED CONTROL OF DIVERSE ELECTROMECHANICAL SYSTEMS USING A COMPUTER NETWORK”, which is hereby incorporated by reference.

Monitors 104A-104C represent various devices or equipment that provide operational data such as temperature data, level data or other automation related data for various types of equipment such as ovens, drink dispensing systems, coffee machines, grease trap monitors etc. Each of monitors 104A-C may be provided by a different vendor, and each may provide data in a proprietary manner that is different from one another. A monitor 104 may provide various functions related to the equipment, including monitoring functions (e.g. providing temperature or level data), control functions (e.g. controlling a switch or thermostat), or asset management functions (providing equipment identification and/or status information). Monitors 104 may be any of a variety of devices used in an automation system, including sensors, switches, actuators and other such devices. Although three monitors 104A-104C have been shown in FIG. 1, it will be appreciated that various embodiments may have more or fewer monitors present in a system.

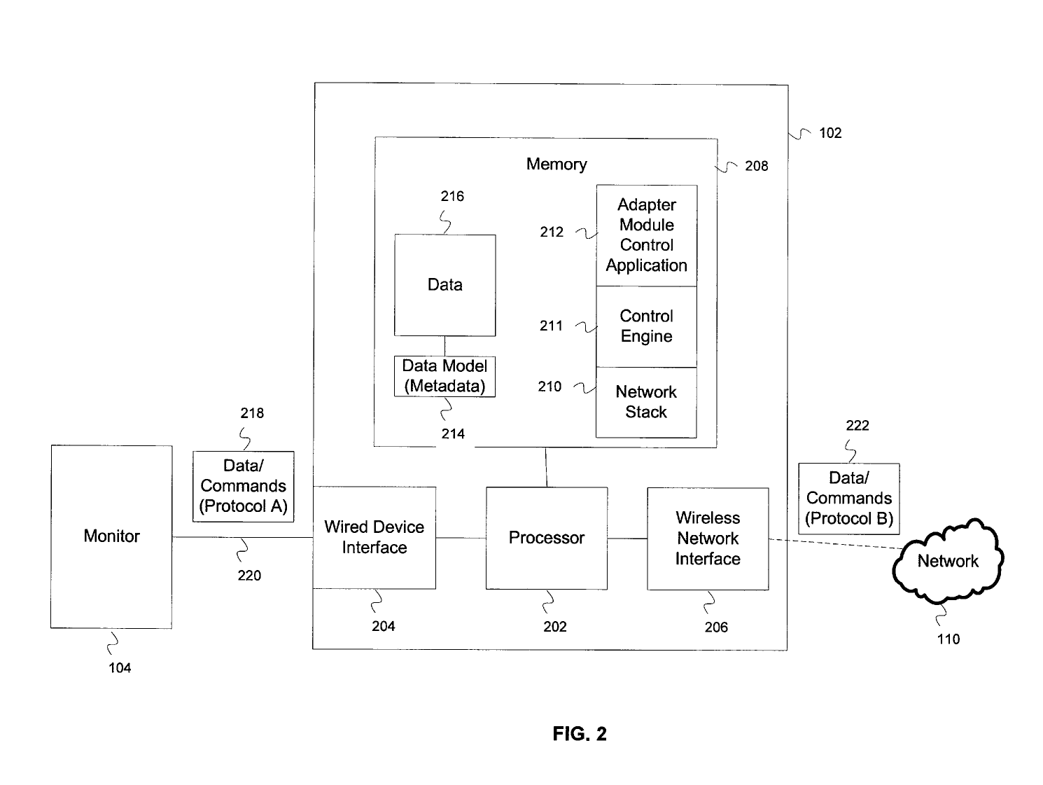

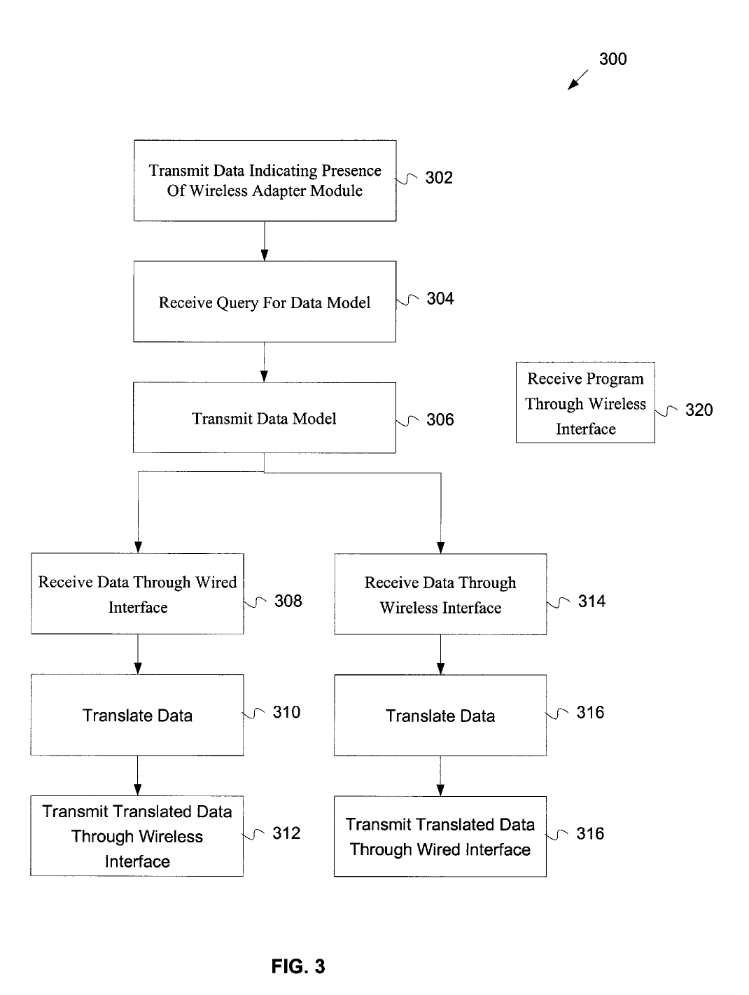

Wireless adapter module 102 includes hardware and software that operates to interface and interact with monitors 104. Wireless adapter module 102 communicates with monitors 104 using a wired interface, and communicates with supervisor control system 106 using a wireless interface. In addition, wireless adapter module 102 may transform data to a format compatible with monitor 104 or supervisor control system 106. Further details on the hardware and software for wireless adapter modules 102 are provided below with reference to FIG. 2 and FIG. 3.

Module programming tool 108 provides an interface for specifying programming that may be used to program a wireless adapter module 102. Further details on a module programming tool 108 used in particular embodiments of the invention is provided in U.S. patent application Ser. No. 11/888,265, filed Jul. 31, 2007 and entitled “PROGRAMMABLE CONTROL ENGINE ON A WIRELESS DEVICE”, which is hereby incorporated by reference.

Network 110 may be used to couple the module programming tool 108, supervisory control system 106 and wireless adapter modules 102. In some embodiments, network 110 is a wireless network, and the wireless adapter modules and other nodes on the network may be organized as a mesh network. A mesh network is desirable, because mesh networks are typically self-healing in that the network can still operate even when a node breaks down or a connection goes bad. As a result, a very reliable network is formed. However, other network topologies such as star or cluster tree topologies are possible and within the scope of the inventive subject matter.

FIG. 2 is a block diagram providing further details and illustrating components of a wireless adapter module 102 according to embodiments of the invention. In some embodiments, a wireless adapter module 102 includes one or more processors 202, a memory 208 a wired device interface 204, and a wireless network interface 206. Processor 202 may be any type of computational circuit such as, but not limited to, a microprocessor, a complex instruction set computing (CISC) microprocessor, a reduced instruction set computing (RISC) microprocessor, a very long instruction word (VLIW) microprocessor, a digital signal processor (DSP), or any other type of processor, processing circuit, execution unit, or computational machine, the invention are not limited to any particular type of processor. Although only one processor 202 is shown, multiple processors may be present in a wireless adapter module 102.

Wired device interface 204 provides an interface to one or more monitors 104. In some embodiments, wired device interface 204 may be a RS232 serial interface, also referred to as a serial port. In alternative embodiments, other wired interfaces may be used and are within the scope of the inventive subject matter.

Wireless network interface 206 provides an interface to network 110. Wireless network interface 206 may be a wireless transceiver. In some embodiments, network interface 206 is a low power wireless network interface 206 and supports the Institute of Electrical and Electronics Engineers (IEEE) 802.15.4 network standard. The IEEE 802.15.4 standard is designed to provide a low data rate communications with multi-month to multi-year battery life and very low complexity. The IEEE 802.15.4 implementation is intended to operate in an unlicensed, international frequency band. Implementation of the IEEE 802.15.4 standard in a wireless adapter module 102 provides for data rates sufficient for communication of automation system data while providing relatively long battery life. In general, the standard provides a CSMA-CA (carrier sense multiple access with collision avoidance) communication protocol, and additionally provides a guaranteed time slot mechanism for high priority communications.

Further, in particular embodiments the wireless network interface 206 may include any of a family of wireless microcontrollers provided by Jennic Ltd. of Sheffield, South Yorkshire, United Kingdom.

Memory 208 stores data and programs executed by processor 202. Although shown as one unit in FIG. 2, memory 208 may include several types of memory including various combinations of RAM, ROM or Flash memory. In some embodiments, memory 208 is used to store a control engine 211, a control application 212 and a network stack 210. Control engine 211 provides software that determines which control applications resident on a wireless adapter module are executed and provides an interface for updating and running control applications 212 that run on the wireless adapter module 202.

Control application 212 runs on a wireless adapter module 102 and provides the customized software required for a particular wireless adapter module 102. Further details on methods of operation of a control application 212 are provided below with reference to FIG. 3.

Network stack 210 provides software layers that provide an interface between the software of the control engine 211 and control application 212, and wireless network interface 206. In some embodiments the network stack includes a physical layer that conforms to the IEEE 802.15.4 standard. The network layer may conform to the Internet Protocol (IP) V4 or V6 standards. Use of the IPV6 standard may be desirable if support for a large number of nodes in an automation system is necessary.

In some embodiments, the network stack 210 may conform to a 6LowPAN network stack, which is designed to use a compressed version of IPV6, over a low-powered, low-data-rate network. Further details on a 6LowPAN stack may be found in the document “draft-ietf-6lowpan-format-13”, entitled “Transmission of IPv6 Packets over IEEE 802.15.4 Networks” which is hereby incorporated by reference for all purposes.

In further embodiments network stack 210 includes layers that conform to the ZigBee network stack as defined by the ZigBee Alliance. The ZigBee network stack uses the MAC (Media Access and Control) and Physical layers of the 802.15.4 protocol, and provides network, security, and application framework layers that may be used to send and receive network data. ZigBee compliant network stacks may be used to handle multiple traffic types, including periodic data such as data from a sensor, intermittent data such as data from a switch, and repetitive low latency data such as alarm or security related data. Further details on the ZigBee stack may be found in “ZigBee Specification” (document 053474r13), published December, 2006 by the ZigBee Alliance, which is hereby incorporated by reference herein for all purposes.

Memory 208 may be used to store data 216 and a data model 214. Data 216 includes one or more data fields and data structures that contain data to be sent or received to/from a monitor 104 through wired interface 204, or to/from a supervisory control system through wireless interface 206. Various types of data may be stored in data 216, including asset identification data related to a monitor 104, sensor data received from a monitor 104, or control information related to a monitor 104.

Data model 214 describes some or all of data 216. Data model 214 may be referred to as meta-data, that is, data about data. Data model 214 provides a description regarding various fields and data structures in data 216. For example, the data model 214 may describe the format, size, data types etc. of the data fields and data structures in data 216.

Data sent and received by a wireless adapter module conforms to a data transmission protocol. Thus data sent over wired device interface 204 (e.g. an RS232 interface) through a wired link such as a cable 216 may be formatted to conform to an automation protocol 218 suitable for use with a particular monitor 104. Similarly, data sent and received through the wireless network interface 206 may formatted to conform to an automation protocol 220 suitable for use with a particular vendor's supervisory control framework.

### Example Operation

FIG. 3 is a flowchart illustrating a method 300 for operating a wireless adapter module according to embodiments of the invention. Some or all of the methods described below may be executed from a machine-readable medium. Machine-readable media includes any mechanism that provides (e.g., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

In some embodiments, method 300 begins at block 302 with the wireless adapter module transmitting data indicating that the wireless adapter module is present on a wireless network. The data may be transmitted when the wireless adapter module is powered on or reset, at periodic intervals, or upon receiving a request from a supervisory control system (e.g. a “poll”). Such data may be used by the supervisory control system to automatically recognize the wireless adapter module when it is installed and present on a wireless network.

At block 304, in some embodiments the wireless adapter module may receive a query for the data model from a supervisory control system. In response to the request, at block 306 the wireless adapter module transmits the data model to supervisory control system, thereby allowing the supervisory control system to determine what data is available on the wireless adapter module and the format of the available data. The use of a data model provides the ability for a supervisory control system to interrogate a wireless adapter module for the data model without prior knowledge about the wireless adapter module, the monitor connected to a wireless adapter module, or the data model used by the wireless adapter module.

Blocks 308-312 and blocks 314-318 represent paths of data through the wireless adapter module. Blocks 308-312 illustrate data flowing from a monitor device through the wireless adapter module to a supervisory control system. Blocks 314-318 illustrate data flowing from a supervisory control system though the wireless adapter module and to a monitor device. Blocks 308-312 and blocks 314-318 may be executed in parallel, or they may be executed in any order, for example, in the order received at an interface.

At block 308, data is received from a monitor device through a wired interface using a protocol configured for the monitor device. The data may be asset identification data, sensor data such as temperature data, quantity data (e.g., weight, volume, level) or control data such as the current position of a switch, actuator etc.

At block 310, the data is translated into a format compatible with a supervisory control system. The format may be a native format for the supervisory control system, or a format that is learned by the supervisory control system by interrogating the wireless adapter module for the data model. The translations may be referred to as “normalizing” the data. Various forms of translation may be used in varying embodiments. The translations may include various combinations of one or more of the following:
Value translation—one data value may be translated to a second data value, for example using a translation table, scaling factor (e.g. Fahrenheit to Celsius), enumerated values may be translated from one set of enumerated values to a second set of enumerated values.
Range translation—data values received that are in one range may be translated into a second range.
Format translation—variable length data (e.g. text strings) may be translated to fixed length and vice versa. Case conversions may be performed as appropriate. Two or more fields may be combined into one field, or one field may be split into two or more fields. Analog data may be translated to digital data.
Message format translation—The format of the data (e.g. the data structure format or field order) may be translated from one format to a second format.
   The above translations are but some examples of the translation or normalization that may be provided by various embodiments. Other translations, transformations, or normalizations may be used and are within the scope of the inventive subject matter.

At block 312, the translated data is transmitted through the wireless interface to a supervisory control system.

At block 314, the wireless adapter module receives data through the wireless interface using a protocol configured for the supervisory control system.

At block 316, the data received through the wireless interface may be translated such that it may be used by a monitor device coupled to the wireless adapter module. The translations may be any of those described above with respect to block 310, and may be the “reverse” translations to those described at block 310. For example, if a field has been split into two fields when received from the monitor device for transmission to the supervisory control system, then the two fields received from the supervisory control system may be combined into one field when sent to the monitor device.

At block 318 the translated data is transmitted to the monitor device through the wired interface.

It should be noted that not all embodiments require both sets of blocks 308-312 and blocks 314-318. For example, a monitor device that provides a temperature of an oven may only send data and not receive data. Thus only blocks 308-312 may be required. Similarly, a switch device that may only respond to command data received from the supervisory control system may only receive data and not send data. Thus only block 314-318 may be required.

Further, it should be noted that in some embodiments, the wireless adapter module may be operated in a pass-through mode in which data that is received from the wired device interface is not translated, but passed as is to the supervisory control system through the wireless interface. Conversely, data received from the supervisory control system may be passed as is in an untranslated form to the monitor device through the wired interface.

Occasionally, it may be desirable to update the programming of a wireless adapter module in order to perform the translations and other operations described above. At these times, the wireless adapter module may receive new or updated programming through a wireless interface from a module programming tool as illustrated by block 320.

It will be appreciated from the above that wired monitor devices such as sensors, switches, actuators and other devices that may be provided from different vendors using different automation protocols may be adapted for use by a single supervisory control system using the wireless adapter module and methods described above. Thus the systems and methods described above provide a common communications infrastructure that allows a supervisory control system to access a variety of vendor's devices and equipment for monitoring, control and/or asset management.

### General

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims.

Each of the embodiments described herein are contemplated as falling within the inventive subject matter, which is set forth in the following claims.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope of the claims. The claims provided below are hereby incorporated into the detailed description, with each claim standing on its own as a separate embodiment.

What is claimed is:

1. An apparatus comprising:
at least one processor and at least one memory;
a wired interface coupled to the at least one processor; and
a low power wireless network interface coupled to the at least one processor;
wherein the processor is operable to:
receive through the wired interface data conforming to a first automation protocol;
translate the data conforming to the first automation protocol to data conforming to a second automation protocol; and
transmit the data conforming to the second automation protocol through the wireless network interface.

2. The apparatus of claim 1, wherein the processor is further operable to execute instructions operable to:
receive through the wireless interface data conforming to the second automation protocol;
translate the data conforming to the second automation protocol to data conforming to the first automation protocol; and
transmit the data conforming to the first automation protocol through the wired interface.

3. The apparatus of claim 1, wherein the wired interface comprises an RS232C interface.

4. The apparatus of claim 1, wherein the wireless interface includes a physical layer conforming to the IEEE 802.15.4 standard.

5. The apparatus of claim 1, wherein the wireless interface includes interface layers substantially conforming to at least one of a IPV6, 6LowPan stack or a Zigbee interface standard.

6. The apparatus of claim 1, wherein the translation includes one or more of a value translation, a range translation, a format translation, or a message format translation.

7. A method comprising:
receiving through a wired interface data conforming to a first automation protocol;
translating the data conforming to the first automation protocol to data conforming to a second automation protocol; and
transmitting the data conforming to the second automation protocol through a low power wireless network interface.

8. The method of claim 7, further comprising:
receiving through the wireless interface data conforming to the second automation protocol;
translating the data conforming to the second automation protocol to data conforming to the first automation protocol; and
transmitting the data conforming to the first automation protocol through the wired interface.

9. The method of claim 7, wherein translating the data conforming to the first automation protocol includes translating analog data.

10. The method of claim 7, wherein translating the data conforming to the first automation protocol includes translating string data.

11. The method of claim 7, wherein translating the data conforming to the first protocol includes translating enumeration data.

12. The method of claim 7, wherein translating the data conforming to the first protocol includes translating a message format.

13. The method of claim 7, further comprising:
maintaining a data model for use in translating data to and from the first automation protocol and the second automation protocol; and
transmitting metadata describing the data model through the wireless interface.

14. The method of claim 13, wherein the metadata is transmitted in response to a query received through the wireless interface.

15. The method of claim 7, further comprising transmitting data indicating presence of a wireless adapter module through the wireless interface.

16. A system comprising:
a monitor device operable to provide monitor data;
a wireless adapter module coupled to the monitor device through a wired interface and operable to:
receive the monitor data through the wired interface,
translate the monitor data according to a data model to form translated data, and
transmit the translated data through a wireless interface on the wireless adapter module; and
a supervisory control system operable to receive the translated data through a wireless interface on the supervisory control system.

17. The system of claim 16, wherein the supervisory control system is operable to determine the presence of the wireless adapter module.

18. The system of claim 16, wherein the supervisory control module is operable to query the wireless adapter module for the data model and wherein the wireless adapter module is operable to transmit the data model through the wireless interface to the supervisory control module in response to the query.

19. The system of claim 16, further comprising a module programming tool operable to provide an interface for programming the wireless adapter module by transmitting a wireless adapter program to the wireless adapter module.

20. A machine-readable medium having machine-executable instructions for causing one or more processors to perform a method, the method comprising:
receiving through a wired interface data conforming to a first automation protocol;
translating the data conforming to the first automation protocol to data conforming to a second automation protocol; and
transmitting the data conforming to the second automation protocol through a wireless network interface.
